(19) United States
(12) Patent Application Publication
(10) Pub. No.: US 2006/0202990 A1
(43) Pub. Date: Sep. 14, 2006

(54) Computer graphics system and method for rendering a computer graphic image

(75) Inventors: Bart Gerard Bernard Barenbrug, Eindhoven (NL); Kornelis Meinds, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/545,064

(22) PCT Filed: Feb. 2, 2004
(86) PCT No.: PCT/IB04/50069

§ 371 Date: Aug. 10, 2005

(30) Foreign Application Priority Data
Feb. 13, 2003 (EP) 03100313.0

(51) Int. Cl. G06T 15/50

(52) U.S. Cl. 345/426

(57) ABSTRACT

A computer graphics system according to the invention comprises a model information providing unit (MIU), a rasterizer (RU), MIU a color generator, and a display space resampler (DSR). The model information providing unit (MIU) provides information representing a set of graphics primitives, the information comprising at least geometrical information defining a shape of the RU primitives and appearance information defining an appearance of the primitives. The rasterizer (RU) is capable of generating a first sequence of coordinates ((u₁,v₁)) which coincide with a base grid associated with the primitive, and capable of generating one or more sequences of interpolated values associated with the first sequence comprising a second sequence of coordinates ((u₂,v₂)) for adressing samples of a texture (T2). The color generator assigns a color (Cu,v) to said first sequence of coordinates using said appearance information, and comprises a texture data unit (TDU), a texture space resampler (TSR) and a shading unit (SU). The display space resampler (DSR) resamples the color (Cu,v) assigned by the color generator in the base grid to a representation in a grid associated with a display.

The present invention relates to a computer graphics system and to a method for rendering a computer graphic image.

In three dimensional computer graphics, surfaces are typically rendered by assembling a plurality of polygons in a desired shape. Computer graphics systems usually have the form of a graphics pipeline where the operations required to generate an image from such a polygon model are performed in parallel so as to achieve a high rendering speed.

A computer graphics system is known from U.S. Pat. No. 6,297,833. The computer graphics system comprises a front-end and a set-up stage which provide input for the rasterizer. The rasterizer in its turn drives a color generator which comprises a texture stage for generating texture values for selectable textures and a combiner stage which produces realistic output images by mapping textures to surfaces. To that end the rasterizer generates a sequence of coordinates in display space and calculates by interpolation the corresponding texture coordinates. The combiner stage is configured to generate textured color values for the pixels of the polygonal primitive by blending the first texture value with the color values of the first set to generate first blended values, blending the second texture value with the color values of the second set to generate second blended values, and combining the second blended values with the first blended values.

It is a disadvantage of the known systems that anti-aliasing requires a significant computational effort, as color data has to be computed at a resolution which is significantly higher than the display resolution.

A radically different approach is known from the article, “Resample hardware for 3D Graphics”, by Koen Meinds and Bart Barenbrug, Proceedings of Graphics Hardware 2002, pp 17-26, ACM 2002, T. Ertl and W. Heidrich and M Doggett (editors). Contrary to the system known from U.S. Pat. No. 6,297,833 the rasterizer is capable of traversing a sequence of sample coordinates coinciding with a grid of a texture to be mapped, while the coordinates for the display are interpolated. The resulting pixel values at a display are obtained by mapping the color data calculated for the interpolated display coordinates to the display grid. A resampler unit performing this procedure will be denoted display space resampler (DSR). A resampler which resamples to the grid of a texture, known from U.S. Pat. No. 6,297,833, will be denoted as texture space resampler (TSR).

This graphics system makes it possible to render an anti-aliased image with reduced computational effort. The achieved anti-aliasing quality is superior to that obtained by 4×4 super-sampling, while the off-chip memory bandwidth and the computational costs are roughly comparable with 2×2 supersampling.

In this article it is however not recognized how programmable pixel shading, comprising features as dependent multi-texturing (e.g. as used for bumped environment mapping) can be realized in a graphics system as described therein.

It is a purpose of the invention to provide a computer graphics system which is capable of rendering images with a relatively wide range of visual effects with a relatively small computational effort.

According to this purpose the computer graphics system of the invention is characterized by claim 1.

In the computer graphics system according to the invention the rasterizer generates a regular sequence of coordinates on a grid in a space associated with the primitive on the basis of the geometric information of the primitive. The wording “associated” denotes that the sequence of coordinates traversed by the grid is determined by the primitive. It is capable of generating the sequence so as to coincide with a grid of a texture. The color generator assigns a color to said coordinates using said appearance information. The so obtained color samples are resampled to a grid in display space by the display space resampler. Compared to the method known from U.S. Pat. No. 6,297,833 proper filtering is simplified significantly. In the first place it is easier to determine which color samples contribute to a particular pixel. Because the footprint of the prefilter required for anti-aliasing is aligned with the axes defining the display space, it is simple to determine if a texture coordinate, mapped in display space, is within said footprint of a pixel. Furthermore, contrary to inverse texture mapping, it is not necessary to transform the filter function from pixel space to texture space. Finally because the rasterization takes place in a space associated with the primitive only coordinates in said space restricted to the primitive are considered for the filtering process. The texture space resampler in the color generator makes it possible to resample texture data provided by the texture data unit to the base grid from an arbitrary grid. The rasterizer is capable of generating one or more sequences of interpolated values associated with the first sequence comprising a second sequence of coordinates for adressing samples of a texture. The wording “associated” here indicates that for each coordinate of the first sequence there is a corresponding value, or coordinate for the second sequence. The relation between the first and the second sequence of coordinates is for example dependent on the orientation of the primitive in relation to the environment. In this way it is not only possible to map simple textures, but also to map environment data. The shading unit in the color generator enables a relatively wide range of visual effects. This makes it possible to apply shading programs suitable for systems as described in U.S. Pat. No. 6,297,833, using effects as multiple texturing, dependent texturing and other forms of pixel shading. Contrary to the system known from U.S. Pat. No. 6,297,833 however, the computer graphics system of the invention comprises a texture space resampler which resamples the texture data to the space defined by the base grid. As will be set out in more detail in the description of the drawings this overcomes the need of large buffers.

If possible the base grid is the grid of a texture. This overcomes the need to resample that texture. Resampling would entail an additional computational effort and a loss of image quality.

However, cases may occur where no suitable texture is associated with the primitive. Such a case is, for example, a texture described by a 1D pattern, which might for example be used to render a rainbow. Another example is a texture stored as a 3D (volumetric) pattern. The embodiment of claim 3 also allows rendering images using such textures by selecting a dummy grid.

In the embodiment of claim 4 the rasterizer in addition generates a sequence of coordinates in display space associated with the input coordinates. This has the advantage that the coordinates in display space can simply be calculated by interpolation. Alternatively the positions in display space can be calculated by a separate transformation unit, but this requires floating point multiplications and divisions.

The embodiment of claim 5 significantly increases the opportunities for special effects. By feedback of texture data as input coordinates to the texture space resampler it is possible to apply so-called bumped environment mapping as described in “Real-Time Shading”, by M. Olano, J. C. Hart, W. Heidrich, M. McCool, A K Peters, Natick, Massachusetts, 2002, page 108.

The embodiment of claim 6 further reduces the computation for those cases in which only simple textures are mapped to the surface of the primitive. The definition of simple textures excludes environment data and cases wherein the textures are defined recursively as in bumped environment mapping. When mapping one or more simple textures the rasterizer can simply generate the input coordinates in a grid that corresponds to the grid in which the textures are stored. The bypass means enable the rasterizer to directly provide the texture information unit with texture coordinates. The bypass means may for example be a separate connection from the rasterizer to the texture information unit. Otherwise it may for example be a module of the texture space resampler which causes the latter to resample in a grid corresponding to the grid generated by the rasterizer.

The rasterisation grid selection unit in the embodiment according to claim 7 chooses a grid over the primitive. If any non-dependently accessed 2D textures are associated with the primitive, the selection unit selects from these, the texture map with the highest resolution (and therefore potentially the highest image frequencies). This guarantees maximum quality, since this texture does not need to be resampled by the texture space resampler. In case no suitable 2D texture map exists, a “dummy” grid over the primitive is constructed for the rasteriser to traverse, and on which the pixel shading is performed. In this way, primitives are supported with a wide variety of shading methods (next to application of 2D textures), such as primitives which are shaded with simple Gourraud shading, procedural shading, 1D textures, 3D textures etc.

By choosing the grid of the texture which is available in the highest resolution as claimed in claim 8, an optimum quality is obtained when resampling other texture data to this grid.

The embodiment of claim 9 has the advantage that sampling distance can be adapted to a value which gives an optimal combination of image quality and computational simplicity. This is in particular advantageous in an embodiment where the texture data is provided by a mipmap. A portion of the mipmap can be selected which best matches with the sampling distance.

The invention further encompasses the method for rendering a computer graphic image according to claim 10.

These and other aspects of the invention are described in more detail with reference the drawings. Therein

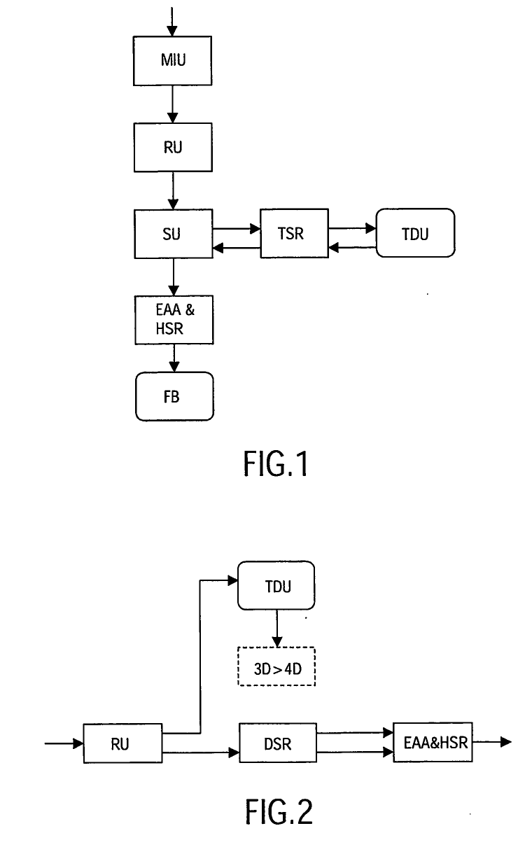

FIG. 1 schematically shows a prior art computer graphics system,

FIG. 2 schematically shows another prior art computer graphics system

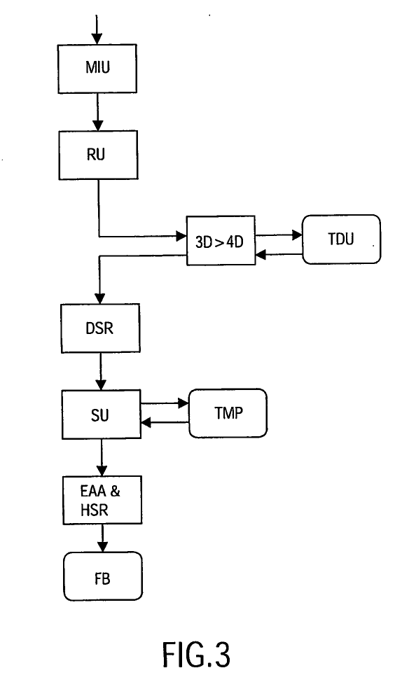

FIG. 3 schematically shows a computer graphics system constructed by combining the computer graphics systems shown in FIGS. 1 and 2,

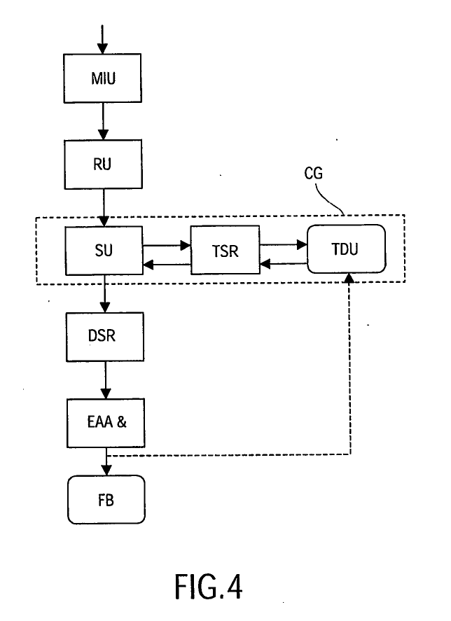

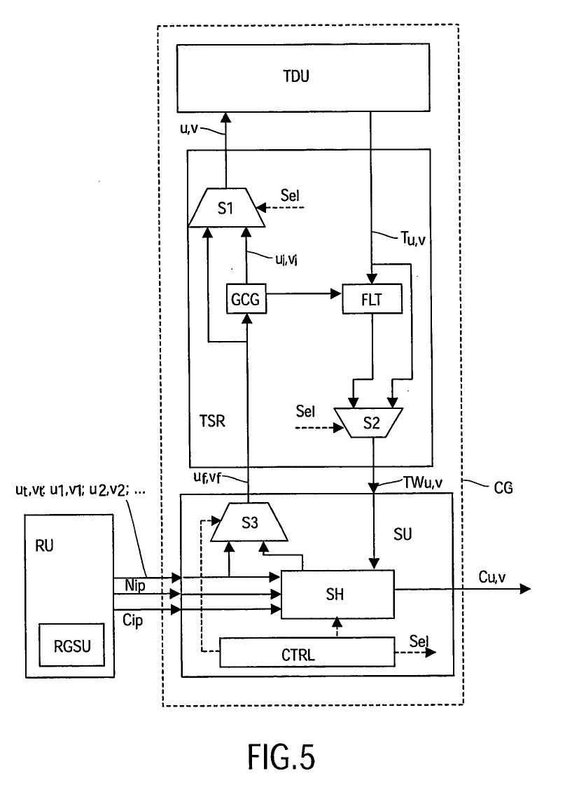

FIG. 4 schematically shows a graphics system according to the invention,

FIG. 5 shows in more detail the color generation unit of the computer graphics system of FIG. 4,

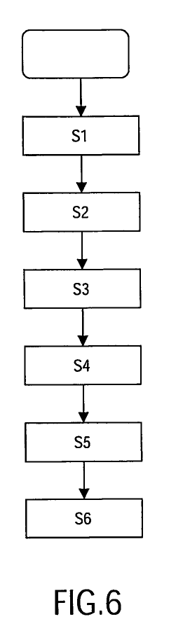

FIG. 6 schematically shows a method of operation,

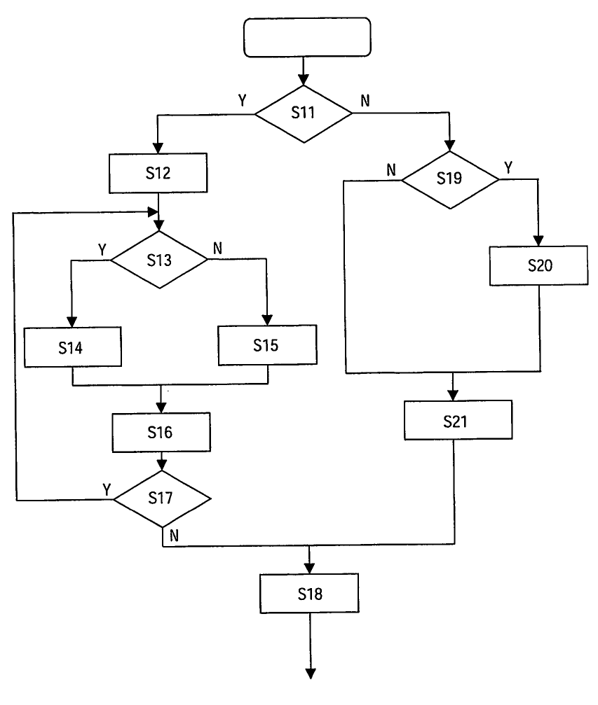

FIG. 7 schematically illustrates an aspect of the operation,

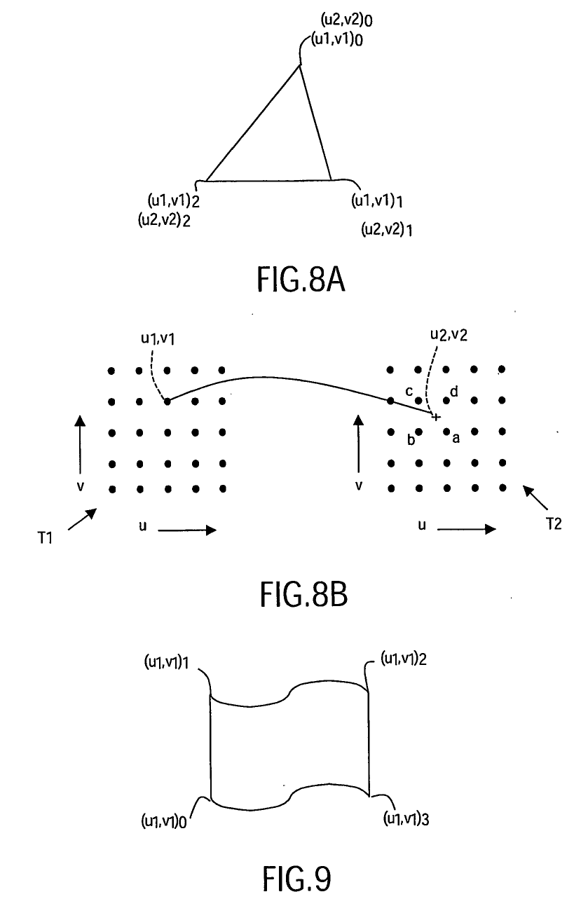

FIG. 8A shows a first example of a primitive,

FIG. 8B schematically illustrates a further aspect of the operation,

FIG. 9 shows a second example of a primitive,

FIG. 1 schematically shows a prior art computer graphics system, which is arranged as a graphics pipeline. The known graphics pipeline comprises a model information retrieving unit MIU, e.g. including a vertex shader, that provides a rasterizer RU with primitives. Each primitive may comprise a set of data associated with a geometrical unit such as a triangle. The data comprises geometrical data, e.g. the coordinates of the vertices of the and appearance data The model information retrieving unit, can be programmed, for example, via the OpenGL or Direct3D API. An application programmer can let the vertex shader execute a program per vertex, and provide geometrical and appearance data to the vertex shader such as position, normal, colors and texture coordinates for each vertex. A detailed description of a conventional vertex shader can be found in “A user-programmable vertex engine”, Erick Lindholm, Mark J. Kilgard, and Henry Moreton, Proc. Siggraph pages 149-158, August 2001.

The rasterizer RU traverses these primitives to supply a shading unit SU with information indicative for addresses within one or more associated texture maps. One or more texture space resamplers TSR subsequently obtain texture data from the adresses indicated by the rasterizer. The color information provided by the texture space resamplers is aligned according to a grid corresponding to the space in which it is displayed, i.e. the display space. The shading unit SU combines the color information according to the current shading program. The result of this combination is either used as an address in the texture data unit TDU in a next pass, or forwarded to the edge anti-aliasing and hidden surface removal EAA & HSR subsystem. Usually, the EAA & HSR subsystem uses super-sampling or multi-sampling for edge anti-aliasing, and z-buffer techniques for hidden surface removal. The final image provided by the EAA & HSR subsystem is stored in a frame buffer FB for display.

FIG. 2 schematically shows a part of the computer graphics system according to the article “Resample hardware for 3D Graphics” mentioned above. In response to an input flow of primitives a rasterizer RU generates a sequence of texture coordinates for a texture data unit TDU and provides a mapped reconstruction filter footprint to a display space resampler DSR which resamples the texture data provided by the texture data unit to display space. The texture data unit TDU may be coupled to the display space resampler DSR via a 4D mipmap reconstruction unit 3D>4D. The display space resampler DSR forwards the pixel data to an edge antialiasing and hidden surface removal unit EAA&HSR.

In the known computer graphics system shown in FIG. 1 the texture space resampler TSR provides the shading unit SU with colors and data on the pixel grid in display space. Subsequently, in display space they are combined. Applying this teaching for the computer graphics system in FIG. 2, means that the shading unit SU should be placed after the display space resampler DSR This leads to the combined architecture shown in FIG. 3.

In the combined architecture shown in FIG. 3 the rasterizer RU controls a very simple texture fetch unit. Apart from a texture data unit TDU it may comprise a simple filter 3D>4D to reconstruct 4D mipmap texture data on the fly from the standard 3D mipmaps stored in the texture memory as described in PHNL010924, filed as IB02/05468. No other filtering needs to be performed to obtain the colors on the texture grid traversed by the rasterizer. The display space resampler DSR takes these colors along with the mapped texture coordinates, and resamples these to the pixel grid on the display. For each texture map, this provides a “layer” of colors in display space. The shading unit can combine all the layers into the final pixel fragment. In effect, this approach results in a per-primitive multi-pass texturing method for pixel shading. This has two main disadvantages.

First, the display space resampler DSR delivers the pixel fragment colors for its texture in an order corresponding to the texture grid, and since this order might be different for different texture maps, a buffer TMP is needed to store the (combined) colors from previous layers before the shading unit SU can combine the colors from the current layer. This results in overhead, in the form of required extra memory bandwidth. A tile based rendering architecture might mitigate this problem, but would be more complicated.

Second, a multipass approach such as this can not cope with dependent texturing, and this is a vital feature in the pixel shading units of today's GPUs.

FIG. 4 shows an embodiment of a computer graphics system according to the invention which overcomes these disadvantages. It comprises a model information providing unit MIU, possibly comprising a programmable vertex shader, for providing information representing a set of graphics primitives. FIG. 8A schematically shows a primitive in the form of a triangle. A first sequence of coordinates can be generated which is associated with the primitive by generating pairs of integer values which are bounded by the coordinates (u₁,v₁)₀, (u₁,v₁)₁, and (u₁,v₁)₂ of the triangle. In other embodiments arbitrary polygons may be used. Instead of planar, curved primitives, as shown in FIG. 9, may be used such as Bezier shapes. Such primitives can be simply parameterized by a pair of parameters and having boundaries for the lower and upper values of these parameters. FIG. 9 shows an example of a surface bounded by four pairs of coordinates. However three pairs, representing a Bezier triangle, suffice. Alternatively a number higher than 4 may be used. With each pair of boundaries a texture coordinate (u₁,v₁)₀, (u₁,v₁)₁, (u₁,v₁)₂ and (u₁,v₁)₃ can be associated. Then, analogously, a first sequence of coordinates can be generated which is associated with the primitive by generating pairs of integer values which are bounded by said texture coordinates. The information comprises at least geometrical information defining a shape of the primitives such as the display coordinates of its vertices (not shown) and appearance information defining an appearance of the primitives. Appearance information may comprise texture information, e.g. in the form of texture coordinates and color information, i.e. diffuse color and/or specular color. Furthermore a fog color can be used to simulate fog. By way of example the coordinates of a first and a second texture are shown related to the vertices of the primitive in FIG. 8A. The grid of the first texture Ti serves as the base grid. The coordinates for the first texture and the second texture are (u1,v1)ᵢ, and (u2, v2)ᵢ, respectively, where i is the number of the vertex. Also information representative for the normal of the primitives at position of the vertices may be included.

A model information providing unit is well known. A programmable vertex shading unit for use in a model information providing unit is for example described in more detail in the above-mentioned article of Lindholm et all. The model information providing unit MIU can be programmed via the OpenGL and Direct3D API.

The computer graphics system according to the invention further comprises a rasterizer (RU) capable of generating a first sequence of texture sample coordinates for addressing samples of a first texture, which coincide with a base grid associated with the primitive, here a grid coinciding with the first texture. It is also capable of generating one or more sequences of interpolated values associated with the first sequence comprising a second sequence of coordinates for addressing samples of a second texture. The rasterizer RU is further capable of generating a first sequence of coordinates according to a dummy grid. This is relevant in the case that no texture is associated with the primitive, or if the texture is not suitable for a two-dimensional grid. This is the case, for example, for a texture described by a 1D pattern, which might for example be used to render a rainbow. Another example is a texture stored as a 3D (volumetric) pattern. The one or more sequences of interpolated values are associated with the first sequence of coordinates in that the rasterizer generates an interpolated value for each coordinate in the first sequence. The interpolated values may be generated at the same time that the first sequence of coordinates is generated, but alternatively may be generated afterwards.

A rasterizer is well known as such. A detailed description of a rasterizer is given in “Algorithms for Division Free Perspective Correct Rendering” by B. Barenbrug et all., pp. 7-13, Proceedings of Graphics Hardware 2000.

The computer graphics system according to the invention further comprises a color generator for assigning a color to said first sequence of coordinates using said appearance information related to the primitives. The color generator CG comprises a texture data unit TDU for assigning texture data to the texture sample coordinates. The texture data unit TDU is for example a texture synthesizer, which synthesizes a texture value for each coordinate. Otherwise it may be a memory in which predefined textures are stored. The textures may be stored in a compressed format. The memory may also contain multiple copies of the textures stored at a different scale. Known methods to implement this are for example the 3D and the 4D mipmap.

The color generator CG further comprises a texture space resampler TSR (shown in more detail in FIG. 5) which is arranged for providing output texture data TWu,v in response to texture sample coordinates ufvf provided by the shading unit SU. In order to provide the output texture data TWu,v it generates texture sample coordinates (uᵢ,vᵢ) aligned with the grid of the second texture T2. Subsequently it fetches data Tu,v from the second texture T2 at those coordinates and resamples the fetched texture data Tu,v to the grid of the first texture T1. In this way texture maps which do not share the same grid can be combined. Contrary to the texture space resampler TSR known from the prior art, the texture space resampler TSR in the computer graphics system of the invention is driven with coordinates which correspond to a grid position on the first texture, and not with a grid position corresponding to a grid position on the display.

In practice an arbitrary number of texture maps e.g. 8 or higher may be used to define the appearance of the primitives. These texture maps may be resampled sequentially, but alternatively the color generator may have more than one texture space resampler and more than one texture data unit in order to speed-up the resampling process.

The color generator CG further comprises a shading unit SU for providing the color using said output texture data and the appearance information provided by the rasterizer. Apart from the texture data, the shading unit may use various data to provide the color, such as an interpolated diffuse color and a normal for calculating a contribution of specular reflection.

Subsequently the display space resampler DSR resamples the color assigned by the color generator to a representation in a grid associated with a display. This process of forward mapping the color to the display grid is preferably performed in two passes, wherein two 1D filtering operations are performed after each other in mutually transverse directions. Alternatively however, the mapping to display coordinates could take place in a single 2D filtering operation. Forward mapping color data is described in detail in the aforementioned article “Resample hardware for 3D Graphics”.

The data provided by the display space resampler DSR is processed by an anti-aliasing and hidden surface removal unit EAA&HSR. Details thereof can be found in the earlier filed patent application PHN020100, with filing number EP02075420.6. The output data of this unit can be provided to a framebuffer for display or, as indicated by the dashed line, to the texture data unit TDU for use in a later stage.

FIG. 5 shows again the rasterizer RU, and the texture data unit TDU, as well as, in more detail, the texture space resampler TSR and the shading unit SU of the computer graphics system according to the invention.

In the embodiment shown in FIG. 5 the texture space resampler TSR comprises an grid coordinate generator GCG for generating integer coordinates (uᵢ,vᵢ) from the coordinates (u_{f},u_{f}). Although in the embodiment shown the textures are addressed by two dimensional coordinates, it is alternatively possible to use higher dimensional coordinates or one-dimensional coordinates instead. A selection element S1 controlled by a selection signal Sel allows either to forward the coordinates (u_{f}, v_{f}) unchanged to the texture data unit TDU, or to select the resampled coordinates (uᵢ,vᵢ).

The rasterizer RU is arranged for generating a regular sequence of coordinates (u₁,v₁) on a base grid. The range traversed by this sequence is determined by the data associated with the primitive. To that end the texture data unit TDU is coupled to the rasterizer RU, in casu via a selection element S3 of the shading unit SU and via a selection element S1 of the texture space resampler TSR.

The rasterizer RU comprises a rasterization grid selection unit RGSU for selecting a base grid to be traversed by the first sequence of coordinates (u₁,v₁).

The base is preferably the grid of a further texture T1. In particular, where two or more textures T1, T2 are associated with the primitive the rasterization grid selection unit RGSU selects the grid of the associated texture T1 which is available at the highest resolution.

However, if no suitable texture is available, a dummy grid is selected as the base grid. The rasterizer RU is capable of adapting the sampling distance stepwise as a function of the relation between a space associated with the primitive and the space associated with the display. This is the case where a texture is stored in the form of a 3D or 4D mipmap, and a perspective mapping causes the magnification of the texture to vary.

The rasterizer RU is further arranged to interpolate other data related to the primitive, such as coordinates of one or more further textures. The rasterizer RU provides the interpolated further texture coordinates (u₂,v₂) to the texture space resampler TSR. In case that these interpolated further texture coordinates coincide with the grid of the second texture T2 these coordinates can be passed to the texture data unit IDU via the selection elements S3 and S1. In case however that the further texture coordinates (u₂,v₂) do not coincide, integer values (uᵢ,vᵢ), coinciding with the grid of the texture, can be calculated by the grid coordinate generator GCG. This is schematically shown in FIG. 8B. The selection element S1 then selects the resampled texture coordinates (uᵢ,vᵢ) as the coordinates for addressing the texture data unit TDU. As shown in FIG. 8B, the coordinate (u₂,v₂) is surrounded by 4 samples a-d of the second texture. The texture space resampler TSR fetches the corresponding texture data of the second texture T2 from the coordinates provided by the grid coordinate generator GCG and the filter FLT resamples these to the grid of the first texture T1. Resampling may take place for example by nearest neighbor approximation, in which case the filter FLT simply passes on the one value Tuv generated by the TDU as a result of the nearest texture coordinate ui,vi generated by the GCG as the output texture value TWu,v. Alternatively the filter may cause the selection element S2 to perform this function by selecting the texture data Tu,v provided by the texture data unit TDU, instead of the output of the filter FLT. Alternatively, resampling may take place by interpolation, for example, by bilinear interpolation. When using interpolation the addressed texture data Tu,v is weighted by a filter FLT which is controlled by the grid coordinate generator GCG. The value calculated by the filter FLT is provided via selection element S2 to the shading unit SU as the output texture value TWu,v. This mode is known as bilinear filtering. It is remarked that the texture space resampler TSR may calculate the output texture value TWu,v on the basis of more output coordinates (uᵢ, vᵢ).

In practice texture data is often stored in the form of a 3D mipmap. This may have the consequence that no sequence of sample coordinates can be found which coincides with the texture grid. However the method describes in PHNL010924, filed as IB02/05468 enables to calculate 4D mipmap data on the fly from the 3D mipmap. This calculation, also based on bilinear interpolation can be performed by the texture space resampler TSR.

The rasterizer RU in addition provides the interpolated color values Cip and the interpolated normal values Nip to the shading unit SU.

As shown in the figure the shading unit comprises apart from the selection element S3, a shading module SH and a programmable controller CTRL. As illustrated by dashed lines, the controller CTRL controls the switches S1,S2 and S3 and the shading module SH.

The shading module SH makes it possible to calculate a color Cu,v in response to several input data such as the interpolated normal Nip and the interpolated color value Cip from the rasterizer and the texture data TWu,v provided by the texture space resampler TSR, as well as environment data (such as information about the position an properties of lightsources). The shading module SH may use well known shading functions, such as Phong shading for that purpose.

Shading methods are described for example in: “The PixelFlow Shading System, a shading language on graphics hardware:”, by M. Olano and A. Lastra, in proceedings Siggraph (July 1998), pp 159-168. See also the Microsoft DirectX Graphics Programmers Guide, DirectX 8.1 ed. Microsoft Developer's Network Library, 2001 and the book “Real-Time Shading”, by M. Olano, J. C. Hart, W. Heidrich, M. McCool, A K Peters, Natick, Massachusetts, 2002.

The shading unit SU provides the output color value Cu,v to the display space resampler DSR which resamples this value to the display coordinates derived. To that end the rasterizer RU may provide interpolated values for the display coordinates.

As shown in FIG. 5, an output of the shading module SH is coupled via the switching element S3 to the texture space resampler TSR.

The feedback facility enables special effects as bumped environment mapping, by reusing the output texture value TWu,v to generate the coordinates of another texture, for example adding these output texture values TWu,v to the input coordinates (uₜ,vₜ) or by using these output texture values TWu,v directly as feedback coordinates (u_{f},v_{f}). Usually these feedback coordinates are not aligned with the grid. The grid coordinate generator GCG generates texture grid aligned values (uᵢ, vᵢ) from the coordinates (u_{f},v_{f}).

The method for rendering a computer graphic image according to the invention is schematically illustrated in the flow chart of FIG. 6. As illustrated therein the method comprises comprising the following steps.

In step S1 information is provided which represents a graphics model comprising a set of primitives. The information comprises at least geometrical information indicative for the shape of the primitives and appearance information indicative for the appearance of the primitives.

In step S2 a first sequence of coordinates is generated coinciding with a base grid associated with the primitive.

In step S3 one or more sequences of interpolated values are generated which are associated with the first sequence, and which comprise a second sequence of coordinates for addressing samples of a texture. Step S3 may be executed subsequent to step S2 as shown in the flow chart, but may alternatively be executed in parallel with step S2. The base grid may be a dummy grid, or a grid for a further texture.

In step S4 output texture data aligned with the base grid is obtained by generating coordinates aligned with the texture from the second sequence, fetching data of the texture at those coordinates and providing the output data as a function of the fetched data.

In step S5 a color is provided using said output texture data and the appearance information. In step S6 the color so obtained is resampled to a representation in a grid associated with a display.

The operation of the color generator is described in more detail with reference to the flowchart of FIG. 7. In step S11 it is determined whether the appearance of the primitive is determined by two or more textures. If this is the case a texture counter i is initialized at 0 in step S12.

Then in step S13 it is verified whether the grid of the current texture i coincides with the grid traversed by the sequence of texture sample coordinates. If this is the case program flow continues with step S14 and fetches a texture sample Tu,v at that coordinate. If the grid of the texture i does not coincide with the sequence of texture sample coordinates a texture sample TWu,v is obtained by a resampling routine in step S15, which uses a filter (such as a bilinear probe, or a higher order filter) to obtain an interpolated texture value from the texture values surrounding the texture sample coordinates. Alternatively it could simply obtain the texture value Tu,v at the nearest grid point of the texture i. Step S15 may include generation or modification of sample coordinates using earlier calculated texture data and/or using other momentaneously available shading data, such as interpolated color Cip and the interpolated normal Nip. In this way dependent texturing effects, such as bumped environment mapping, can be obtained.

After step S14 or step S15 program flow continues with step S16 where the momentaneously available shading data, such as interpolated color Cip, interpolated normal Nip and texture data is combined.

Step S16 is followed by step S17 where it is verified whether there are further textures associated with the primitive. If so, the texture counter is incremented and steps S13 until and including S17 are repeated. If it is determined in step S17 that the last texture was processed, a combined color is calculated using the texure values TWu,v, the interpolated color Cip and other data, such as the interpolated normal Nip.

After the last texture of the primitive has been processed, the calculated color value Cu,v is used in step S18 as input value for the next processing stage, for example the forward filtering operation that resamples the calculated color value to display coordinates as is described with reference to FIG. 4. Before or after the forward filtering operation one or more other processing steps may be performed, such as an alpha-test, depth-test and stencil-test procedures.

If it was determined in step S11 that the appearance of the primitive is determined by less than two textures, step S19 is executed. Step S19 verifies whether there is exactly one texture. If this is the case the texture value of the present sample coordinate is retrieved in step S20. This step S20 can either straightforwardly retrieve a texture sample as in step S14, when the sample coordinate coincides with the grid of the texture. Or, if the sample coordinate does not coincide with the texture grid it may calculate a texture value analogous to the procedure in step S15. Subsequently program flow continues with step S21. If it is determined in step S19 that there is no texture associated with the primitive, control flow directly continues with step S21. In step S21 other color computations may take place, for example using a diffuse color Cip and an interpolated normal Nip, which is followed by step S18.

1. Computer graphics system comprising
a model information providing unit (MIU) for providing information representing a set of graphics primitives, the information comprising at least geometrical information defining a shape of the primitives and appearance information defining an appearance of the primitives,
a rasterizer (RU) capable of generating a first sequence of coordinates ((u₁,v₁)) which coincide with a base grid associated with the primitive, and capable of generating one or more sequences of interpolated values associated with the first sequence comprising a second sequence of coordinates ((u₂,v₂)) for adressing samples of a texture (T2),
a color generator for assigning a color (Cu,v) to said first sequence of coordinates using said appearance information, the color generator comprising
a texture data unit (TDU) for assigning texture data (Tu,v) to the texture coordinates and a texture space resampler (TSR) arranged for providing output texture data (TWu,v) by generating texture coordinates aligned with the grid of the texture (T2) from the second sequence of coordinates, fetching data from the texture (T2) at the generated texture coordinates and resampling the fetched texture data (Tu,v) to the base grid,
a shading unit (SU) capable of providing the color (Cu,v) using said output texture data and the appearance information provided by the rasterizer, a display space resampler (DSR) for resampling the color (Cu,v) assigned by the color generator in the base grid to a representation in a grid associated with a display.

2. Computer graphics system, wherein the base grid is the grid of a further texture (T1).

3. Computer graphics system, wherein the base grid is a dummy grid.

4. Computer graphics system according to claim 1, characterized in that the rasterizer (RU) in addition is arranged for generating a sequence of coordinates in display space associated with the first sequence of texture coordinates ((u₁,v₁)).

5. Computer graphics system according to claim 1, characterized by a feedback facility (SH, S3,ICG,S1) for providing further texture coordinates (u_{f},v_{f}) to the texture space resampler (TSR) in response to the output texture data (TWu,v).

6. Computer graphics system according to claim 1, characterized by a bypass facility (S3,S1) for enabling the rasterizer (RU) to directly provide the texture data unit (TDU) with texture coordinates ((u₁,v₁)).

7. Computer graphics system according to claim 1, characterized in that the rasterizer (RU) comprises a rasterization grid selection unit (RGSU) for selecting a grid to be traversed by the first sequence of texture coordinates ((u₁,v₁)).

8. Computer graphics system according to claim 7, characterized in that where two or more textures (T1, T2) are associated with the primitive the rasterization grid selection unit (RGSU) selects the grid of the associated texture (T1) which is available at the highest resolution.

9. Computer graphics system according to claim 1, characterized in that the rasterizer (RU) is capable of adapting the sampling distance step-wise as a function of the relation between a space associated with the primitive and the space associated with the display.

10. Method for rendering a computer graphic image comprising the steps of
providing information representing a graphics model comprising a set of primitives, the information comprising at least geometrical information indicative for the shape of the primitives and appearance information indicative for the appearance of the primitives,
generating a first sequence of coordinates coinciding with a base grid associated with the primitive,
generating one or more sequences of interpolated values associated with the first sequence comprising a sequence of texture coordinates for adressing samples of a texture,
providing output texture data aligned with the base grid by
generating texture coordinates aligned with the texture from the second sequence,
fetching data of the texture at the generated texture coordinates and
providing the output texture data as a function of the fetched data,
providing a color using said output texture data and the appearance information
resampling the color so obtained to a representation in a grid associated with a display.
